(19) United States
(12) Patent Application Publication
(10) Pub. No.: US 2008/0106643 A1
(43) Pub. Date: May 8, 2008

(54) METHOD AND APPARATUS FOR VIDEO TRANSMISSION OVER LONG DISTANCES USING TWISTED PAIR CABLES

(75) Inventors: RAYMOND WILLIAM HALL, RIVERSIDE, CA (US); GARY DEAN COLE, Corona, CA (US); Donald E. Parreco, Covina, CA (US)

Correspondence Address: THE HECKER LAW GROUP, 1925 CENTURY PARK EAST, SUITE 2300, LOS ANGELES, CA, 90067, US

(73) Assignee: RGB SYSTEMS, INC., ANAHEIM, CA (US)

(21) Appl. No.: 11/557,938

(22) Filed: Nov. 8, 2006

(51) Int. Cl. H04N 11/06; H04N 5/38; H04N 7/04

(52) U.S. Cl. 348/488; 348/469; 348/723; 348/E11.007; 348/E07.04; 348/E05.093

(57) ABSTRACT

A system capable of transmitting and receiving high frequency video signals across various lengths of a twisted pair cable while maintaining video quality is presented. The system includes a transmitter and a receiver tandem coupled together over twisted pair cable. Each video component is mixed with a reference signal in the transmitter and driven differentially onto the twisted pair cable. Upon detection of a signal in the twisted pair cable, the receiver adjusts its internal gains until the known characteristic of the reference signal is achieved. The receiver than automatically adjusts the skew & DC offset. Thus, the receiver is able to automatically measure the degradation in video quality and appropriately compensate the video signals for the accumulated degradation caused primarily by the transmission between the transmitter and the receiver. The compensated video may subsequently be provided to a video display device.

### FIELD OF INVENTION

This invention relates to the field of video transmission. More specifically the invention relates to transmission of video over long distances using twisted pair cables.

### BACKGROUND OF INVENTION

Cables are one method commonly used to convey electronic video signals from a source device (e.g., a video camera or a DVD player) to a destination device (e.g., a video display screen). Two types of cable commonly used for video transmission are coaxial cable and twisted pair cable. It is desirable for the video signal at the destination device to correspond accurately to the original video signal transmitted by the source device. “Insertion loss” is a term used to describe signal degradation that occurs when a video or other signal is transmitted over a transmission medium such as a cable. Insertion loss is typically caused by the physical characteristics of the transmission cable.

Typically, insertion loss is proportional to the cable length: longer length transmission cables will exhibit greater loss than shorter length cables. Coaxial cables typically exhibit less insertion loss than twisted pair cables. However, coaxial cables are more expensive and difficult to install than twisted pair cables. Twisted pair cables typically are manufactured as bundles of several twisted pairs. For example, a common form of twisted pair cable known as “Category 5” or “CAT5” cable comprises four separate twisted pairs encased in a single cable. CAT5 cable is typically terminated with an eight-pin RJ45 connector.

Insertion loss is typically caused by the physical characteristics of the transmission cable. Insertion loss includes resistive losses (also sometimes referred to as DC losses) as well as inductive, capacitive and skin effect losses (also sometimes referred to as AC losses). The AC insertion loss exhibited by a cable is frequency dependent. For example, the insertion loss for a 1500 foot length of CAT5 cable as a function of frequency is shown in FIG. 11. In the example of FIG. 11, the insertion loss generally increases with increasing frequency, with the insertion loss for high frequency signals being significantly greater (−70 dB at 50 MHz for a 1500 feet CAT-5 cable) than the DC insertion loss of 2.6 dB for 1500 Feet (e.g. the loss at a frequency value of zero).

Video signals come in a variety of formats. Examples are Composite Video, S-Video, and YUV. Each format uses a color model for representing color information and a signal specification defining characteristics of the signals used to transmit the video information. For example, the “RGB” color model divides a color into red (R), green (G) and blue (B) components and transmits a separate signal for each color component.

In addition to color information, the video signal may also comprise horizontal and vertical sync information needed at the destination device to properly display the transmitted video signal. The horizontal and vertical sync signals may be carried over separate conductors from the video component signals. Alternatively, they may be added to one or more of the video signal components and transmitted along with those components.

For RGB video, several different formats exist for conveying horizontal and vertical sync information. These include RGBHV, RGBS, RGsB, and RsGsBs. In RGBHV, the horizontal and vertical sync signals are each carried on separate conductors. Thus, five conductors are used: one for each of the red component, the green component, the blue component, the horizontal sync signal, and the vertical sync signal. In RGBS, the horizontal and vertical sync signals are combined into a composite sync signal and sent on a single conductor. In RGsB, the composite sync signal is combined with the green component. This combination is possible because the sync signals comprise pulses that are sent during a blanking interval, when no video signals are present. In RsGsBs, the composite sync signal is combined with each of the red, green and blue components. Prior art devices exist for converting from one format of RGB to another. To reduce cabling requirements, for transmission of RGB video over anything other than short distances, a format in which the sync signals are combined with one or more of the color component signals are commonly used.

Thus, an RGB signal typically requires at least three separate cables for transmission of each of the red, green, and blue components and the combined horizontal and vertical sync information. If coaxial cable is used, three separate cables are required. If twisted pair conductors are used, three twisted pairs are also required, but a single CAT5 cable (which comprises four twisted pairs) can be used. Three of the four pairs may be used for the red, green, and blue components, respectively. The fourth pair is available for transmission of other signals (e.g., digital data, composite sync, and/or power). FIGS. 2 and 3 illustrate examples of how video signals may be allocated to the four pairs of twisted conductors in a CAT5 or similar cable.

In a CAT5 or similar cable, each end of each conductor is typically connected to one of eight pins of a standard male RJ-45 connector. In FIGS. 2 and 3, the first conductor pair corresponds to Pins 1 and 2; the second conductor pair corresponds to Pins 4 and 5; the third conductor pair corresponds to Pins 7 and 8; and the fourth conductor pair corresponds to Pins 3 and 6. For video signal configurations in which three or fewer conductor pairs are used for the transmission of the video signal, the remaining conductor pair or pairs (for example, the pair corresponding to Pins 3 and 6), may be used for communication of other signals, and/or for power transfer. Power transfer may be desirable if one of the devices is located remote from an external power source. For example, a source device may comprise a self powered laptop computer located at a distance from an external power source, such as a power outlet, while the destination device comprises a video projector display unit located in the ceiling of a room with a readily available AC power source. In such a configuration, the power needed to operate the transmitter may be conveyed from the receiver located near an AC power source via the twisted conductor pair not allocated for transmission of video signals. In such a configuration, the transmitter may be located within a wall or podium (e.g. in the vicinity of the laptop computer) without a nearby power source thus the transmitter can get its power from the receiver which is more likely to have a power source nearby.

FIG. 2 shows example pin configurations for a number of video signal formats. For example, with RGBHV video, as shown in the column headed “RGBHV” of FIG. 2, the twisted pair corresponding to Pins 1 and 2 carries the differential Red signals (i.e. Red+ and Red−) and the differential vertical sync signal (i.e. V Sync+ and V Sync−), the pair corresponding to Pins 4 and 5 carries the differential green signals (i.e. Green+ and Green−), and the pair corresponding to Pins 7 and 8 carries the differential Blue signals (i.e. Blue+ and Blue−) and the differential horizontal sync signal (i.e. H Sync+ and H Sync−). In FIG. 2, the conductor pair corresponding to pins 3 and 6 is allocated to carrying a digital signal and power.

For RGBS (i.e. RGB with one composite sync signal), in the example of FIG. 2, as shown in the column headed “RGBS,” the same pin assignments are used for the red, green and blue components as for RGBHV, with the composite sync signal combined with the Blue signal (i.e. Blue/C Sync+ and Blue/C Sync−). The composite sync signal could alternatively be combined with the Red component signal, or the Green component signal (as is done in the RGsB format, as shown in the column headed “RGsB” in FIG. 2). When the format to be transmitted is RsGsBs (i.e. composite sync signal added to each color component), as shown in the column headed “RsGsBs” in FIG. 2, the same pin assignments are used for each of the red, green and blue components as for RGBHV, except in this case the composite sync signal is added to each of the three color components.

In addition to showing example pin assignments for RGB signals, FIG. 2 also shows example pin assignments for component video, S-Video, and composite video. FIG. 3 shows an example of pin assignments that allow Composite video and S Video signals to share the same four-twisted pair cable.

Whenever multiple cables are used to transmit different components of a video signal, they must be properly combined at the destination to reproduce the transmitted video signal. For example, the components must be synchronized at the receiving station to prevent distortion in the video reproduction. Differences in arrival time of the various signal components may become an issue if the transmission distance is long and there are differences in length among the multiple conductors. Such differences in arrival time are referred to as “skew.” CAT5 or similar twisted pair cables are particularly prone to skew the twist rate of each cable pair is different (to reduce cross-talk between the adjacent cables). Over long distances, this difference in twist rate can result in significant differences in conductor path length of the different pairs.

Although twisted pair cables are convenient and economical for transmission of video signals, signal degradation (skew between video signal components and insertion loss) limits the distance over which satisfactory quality video signals can be transmitted via twisted pair cables. Video transmitter/receiver systems exist that amplify video signals transmitted over twisted-pair cables. In such systems, a transmitter amplifies the video source signal prior to being transmitted over twisted pair cable, and a receiver amplifies the received signal. These transmitter/receiver systems allow longer transmission distances over twisted-pair cable than are possible for unamplified signals. However, to prevent signal distortion, the amount of gain (amplification) supplied by the transmitter and receiver must be properly matched to the amount of insertion loss that occurs in the length of the twisted-pair cable over which the video signal is transmitted. Ideally the system gain should be flat across the frequency spectrum. If the resulting video signal is not flat across the frequency spectrum a smearing of the video image across the display will occur.

However, amplification of the video signal to compensate for insertion loss may result in unacceptably magnifying the noise accumulated over the transmission lines. This is because the signal to noise ratio decreases as the cable length increases. Thus, although a flat frequency response is ideal over a desired frequency spectrum, signal amplification may need to be tempered by noise considerations.

It is not uncommon to find video signals with a DC offset, i.e., steady state signal component that is floating or biased with respect to ground. There are several potential culprits for existence of DC bias in a video signal, e.g., the DC bias may be directly from the video source, AC coupling through a capacitor from the source, or due to processing circuit elements in the receiving device. In order for the receiver to properly detect the synchronization signals and restore the video, the incoming video signal is DC restored.

Therefore, there exists a need for a video transmission system that automatically compensates for signal losses, skew, DC offset, and other unacceptable characteristics of transmission of video signals over appreciable distances via conductors, including twisted pair cables.

### SUMMARY OF THE INVENTION

The invention comprises a transmitter and a receiver tandem coupled together over twisted pair cables for communication of high resolution video signals to greater distances than currently possible with prior art systems. The present invention extends the transmission capabilities of twisted pair video systems by several multiple times the distance of prior art video over twisted pair systems.

One embodiment of the present invention is configured to automatically detect the presence of a signal between the transmitter and the receiver and adjust the video signals accordingly to correct for any losses in the video quality. For instance, when a twisted pair cable is connected between the transmitter and the receiver of the present invention, the receiver detects the presence of video signal in the line and automatically adjusts for DC loss, AC loss, Skew, and offset.

Signal adjustment is done primarily with the synchronization signal. When the receiver is first coupled to the line, it sets the loop gains to maximum in order to facilitate recovery of the synchronization signal. After the synchronization signal is established, the receiver adjusts the DC and/or AC signal amplitude and peaking until the synchronization signal is restored to its proper level.

Once the synchronization signal is restored to the proper level the skew is measured and signals are adjusted to compensate for any skew differences between the conductors in the cable and the receiver.

One or more embodiments of the present invention may also include an appropriate amount of noise filtering for high fidelity restoration of the video signal at the receiver.

Further objects, features, and advantages of the present invention over the prior art will become apparent from the detailed description of the drawings which follows, when considered with the attached figures.

### BRIEF DESCRIPTION OF THE DRAWINGS

FIG. 1 is an illustration of long distance twisted pair transmission apparatus in accordance with an embodiment of the present invention.

FIG. 2 is an illustration of allocation of the conductors of a twisted pair cable for various video formats in accordance with an embodiment of the present invention.

FIG. 3 is an illustration of allocation of the conductors of a twisted pair cable for video signals in accordance with an embodiment of the present invention.

FIG. 4 is a block diagram illustration of architecture of a transmitter in accordance with an embodiment of the present invention.

FIG. 5 is an illustration of a polarity converter in accordance with an embodiment of the present invention.

FIG. 6 is a block diagram illustration of architecture of a receiver in accordance with an embodiment of the present invention.

FIG. 7 is an illustration of a sync stripper circuit in accordance with an embodiment of the present invention.

FIG. 8 is an illustration of insertion loss compensation circuit in accordance with an embodiment of the present invention.

FIG. 9 is an illustration of the skew compensation circuit in accordance with an embodiment of the present invention.

FIG. 10 is an illustration of the DC offset correction circuit in accordance with an embodiment of the present invention.

FIG. 11 is a frequency response plot of an example 1500 feet length CAT5 cable.

### DETAILED DESCRIPTION OF THE INVENTION

The invention comprises a method and apparatus for transmission of video over long distances using twisted pair conductors. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention comprises a transmitter and a receiver tandem coupled together over a twisted pair cable for communication of video signals, e.g. composite video, S-Video, Component video, computer-video, and other high resolution video, over long distances. Embodiments of the present invention extend the transmission capabilities of twisted pair video systems over long distances of twisted pair cable.

Embodiments of the present invention are preferably configured for Plug and Play operation. Thus, when a twisted pair cable is connected between the transmitter and the receiver, with a video signal present, the system detects the presence of the video signals and automatically adjusts for DC loss, AC loss, Skew, and DC offset.

In one or more embodiments, the transmitter is configured to transmit video signals over multiple conductor pairs to a receiver. Each conductor pair carries a component of the video signal. The transmitter obtains input video signals from a video source device (e.g. a video camera or a DVD player). In one or more embodiments, the transmitter modifies the input video signal by removing any DC offset present from the video source. The transmitter may also have a local buffered video output for local monitoring.

Subsequently, the transmitter adds a reference signal having a predetermined form to each component of the input video signal, preferably during the blanking period. The transmitter transmits the modified input video signal over the multiple conductor pairs to the receiver. The receiver processes the modified input video signal and provides a reprocessed video signal to a destination device (e.g. a video recorder or video display).

Processing of each component of the modified video signal at the receiver is done based on the reference signals. In one embodiment, when the receiver is coupled to the transmitter via the conductor pairs, the receiver recognizes that a signal is present at its input terminals and begins processing of the input signals. The receiver attempts to detect the reference signal in each signal component. In one or more embodiments, the receiver comprises a closed loop signal amplifier for each signal component. The receiver initially sets the loop gains of the amplifiers to maximum for purposes of detecting the reference signal. In one or more embodiments, once the reference signal is detected in a particular signal component, the receiver adjusts the DC and/or AC signal amplitude and peaking for that signal component until the reference signal is restored to its original form.

Once the reference signal for each signal component has been restored, skew between the different video signal components is measured. Delay is added to the earliest arriving signal component(s) such that they arrive at the same time as the slowest arriving signal component.

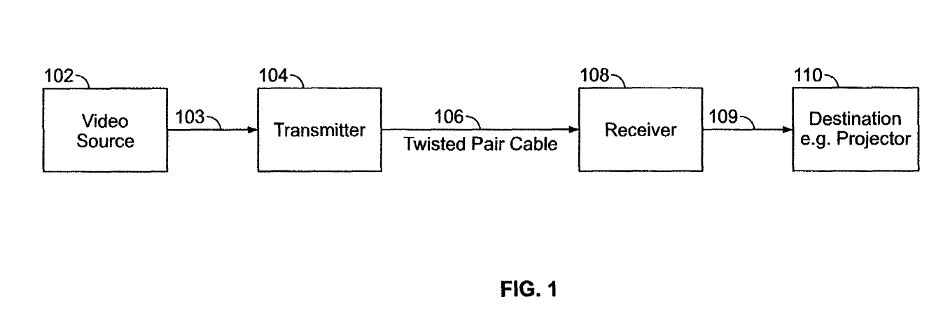

An embodiment of a video transmission system comprising the present invention is illustrated in FIG. 1. As illustrated, the video transmission system comprises video source 102, cable 103, transmitter 104; twisted pair cable 106; receiver 108, cable 109 and destination device 110. Cable 103 couples the video (and audio, if applicable) signals from source 102 to transmitter 104. Cable 103 may comprise any suitable conductors known in the art for coupling the type of video signal generated by video source 102 to transmitter 104. Transmitter 104 comprises multiple input terminals for accepting different input signal formats. For example, transmitter 104 may comprise connectors for accepting a composite video signal, an S-Video signal, a digital video signal, an RGB component video signal, etc. Transmitter 104 may also comprise standard audio connectors such as, for example RCA input jacks.

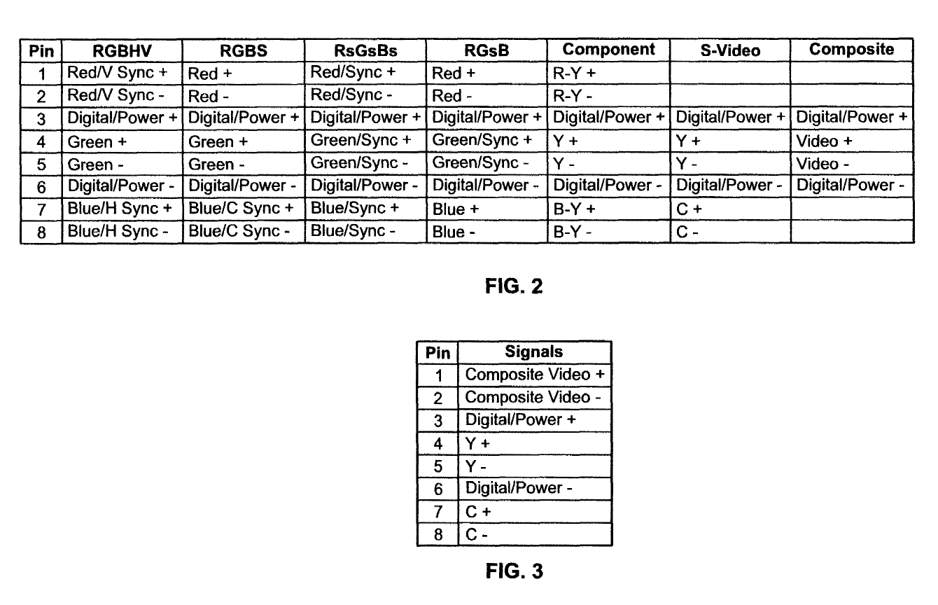

In one or more embodiments, cable 106 comprises a cable bundle of multiple twisted pair conductors. For example, cable 106 may comprise a CAT5 or similar cable comprising four pairs of twisted conductors and terminated with standard male RJ-45 connectors that mate with matching female RJ-45 connectors on the transmitter and receiver. The pairs of twisted conductors may, for example, be allocated as shown in FIGS. 2 and 3.

Example embodiments of the present invention are described using RGBHV as an example video input signal format. However, it will be clear to those of skill in the art that the invention is not limited to RGBHV and that other video formats may be used in which the video signal is transmitted over more than one conductor pair.

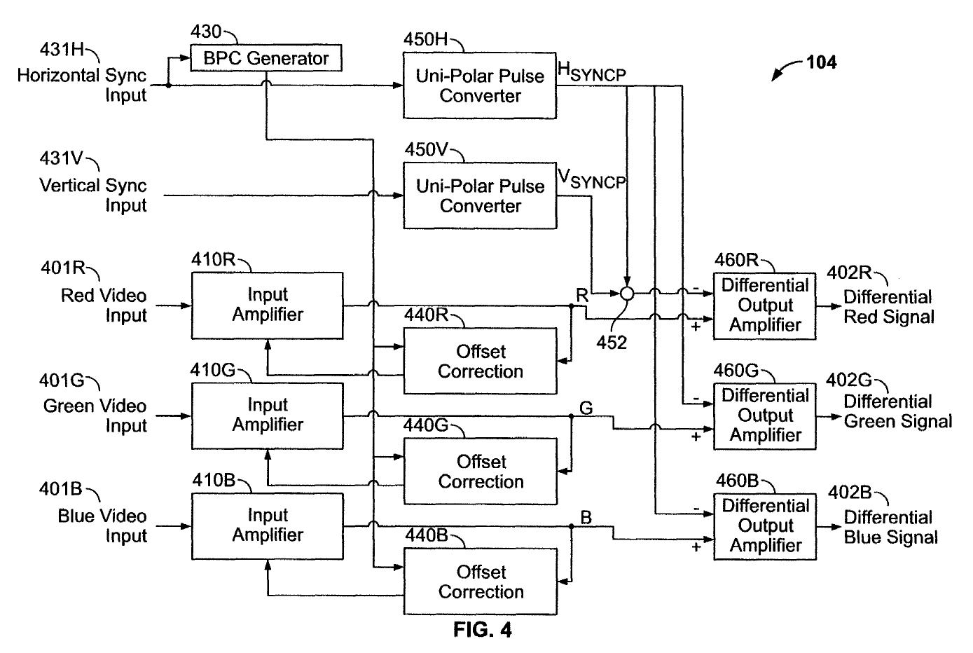

FIG. 4 is a block diagram showing the architecture of transmitter 104 of FIG. 1 in an embodiment of the present invention. In the embodiment shown in FIG. 4, transmitter 104 receives a video source signal comprising separate video input signals and sync input signals. For example, if the video input source signal is in RGBHV format, video input signals comprise the R, G and B signals, while the sync input signals comprise the H and V sync signals. In other embodiments, the sync signals may be combined with one or more of the video component signals.

In embodiments configured for S-Video; Component video; Composite video; or some forms of RGB video with a combined synchronization signal, the synchronization signals may be detected and extracted from the video information and then re-combined, after conditioning, with the video to provide the appropriate reference signals for compensation and skew measurements. In such embodiments, the synchronization signals are stripped from the incoming video signals, conditioned, and then recombined with the appropriate video data, in the transmitter. Thus configured, the input signal at the receiver provides the necessary information for the receiver to detect the insertion loss, compensate for skew, and also re-generate the appropriate synchronization signals for these video formats.

In the RGBHV embodiment of FIG. 4, transmitter 104 comprises horizontal and vertical sync input terminals 431H and 431V, red, green and blue video input terminals 401R, 401G and 401B, input amplifiers 410R, 410G, and 410B, back porch clamp (BPC) generator 430, offset correction circuits 440R, 440G, and 440B, uni-polar pulse converters 450H and 450V, differential output amplifiers 460R, 460G and 460B, and differential output terminals 402R, 402G and 402B. Transmitter 104 may also contain local output amplifiers for each input signal (not shown) that provide a local video monitor output signal.

Input amplifiers 410 receive the input video signal from video input terminals 401, and uni-polar pulse converters 450 receive the sync input signals from sync input terminals 431. In one or more embodiments, separate amplifiers are utilized for each video component signal. For example, in an embodiment for an RGBHV input signal, three input amplifiers 410 for the video components (one each for the R, G, and B components) and two uni-polar pulse converters 450 for the sync signals (one each for the H and V sync signals) are used.

Input amplifiers 410 are used in conjunction with horizontal sync BPC generator 430 and offset correction circuits 440 to detect and compensate for any DC offset in the source video signal. In the embodiment of FIG. 4, offset correction circuits 440 determine the DC offset for each video component using the back porch clamp signal from the BPC generator 430, and the amplified video source signal from input amplifiers 410. Offset correction circuits 440 apply compensation to each video component via a feedback loop comprising the respective input amplifier 410 for that component.

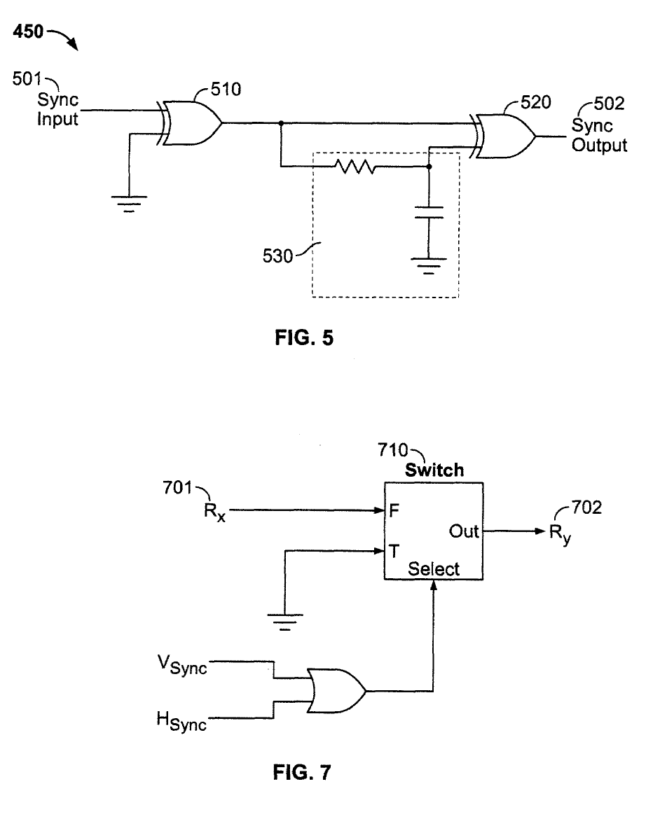

The vertical and horizontal synchronization signals 431H and 431V are coupled to uni-polar pulse converters 450. Uni-polar pulse converters 450 assure that output sync signals from transmitter 104 are always the same polarity regardless of the polarity of the input. An embodiment of a uni-polar pulse converter 450 is illustrated in FIG. 5.

In the embodiment of FIG. 5, pulse converter 450 comprises two exclusive-OR gates (e.g. 510 and 520) that process the received sync input signal. Initially, the sync input signal 501 (e.g. 431H and 431V) is exclusive-ORed with ground in gate 510 and then the output of gate 510 is filtered in low-pass filter 530 (which in one or more embodiments comprises a resistor and capacitor circuit) and exclusive-ORed with itself (i.e. unfiltered output of gate 510) in gate 520 to generate the polarity-corrected sync output signal 502.

In one or more embodiments, the horizontal sync signal H_{SYNCP} is used as both the horizontal sync signal and as the reference pulse signal. H_{SYNCP} is therefore added to each of the video signal component signals. In addition, in one or more embodiments, the vertical sync signal V_{SYNCP} is added to one or more of the video components to provide vertical sync information to the receiver.

As illustrated in the embodiment of FIG. 4, only the red video component signal is used to convey the vertical sync information. Thus, both the vertical and horizontal sync signals are added to the red video component signal, while only the horizontal sync signal is added to the blue and green component signals. H_{SYNCP} is summed with V_{SYNCP} at node 452 and subtracted from the red video component signal (i.e. differentially added) at differential amplifier 460R. H_{SYNCP} is subtracted from the green video component at differential amplifier 460G; and H_{SYNCP} is subtracted from the blue video component at differential amplifier 460B. In this way, a negative reference pulse (i.e. H_{SYNCP}) is simultaneously added to all three differential video output signals.

Differential output amplifiers 460 receive the reference, sync (if applicable) and video signals and provide corresponding amplified differential driver signals to differential output terminals 402. In one or more embodiments, differential output terminals 402 comprise a female RJ-45 connector using pin assignments such as those shown in FIG. 2 (pins 3 and 6 may be used for transmission of power, digital signals, and/or audio signals). Differential output terminals 402 may be connected via twisted pair cable 106 of FIG. 1 to receiver 108.

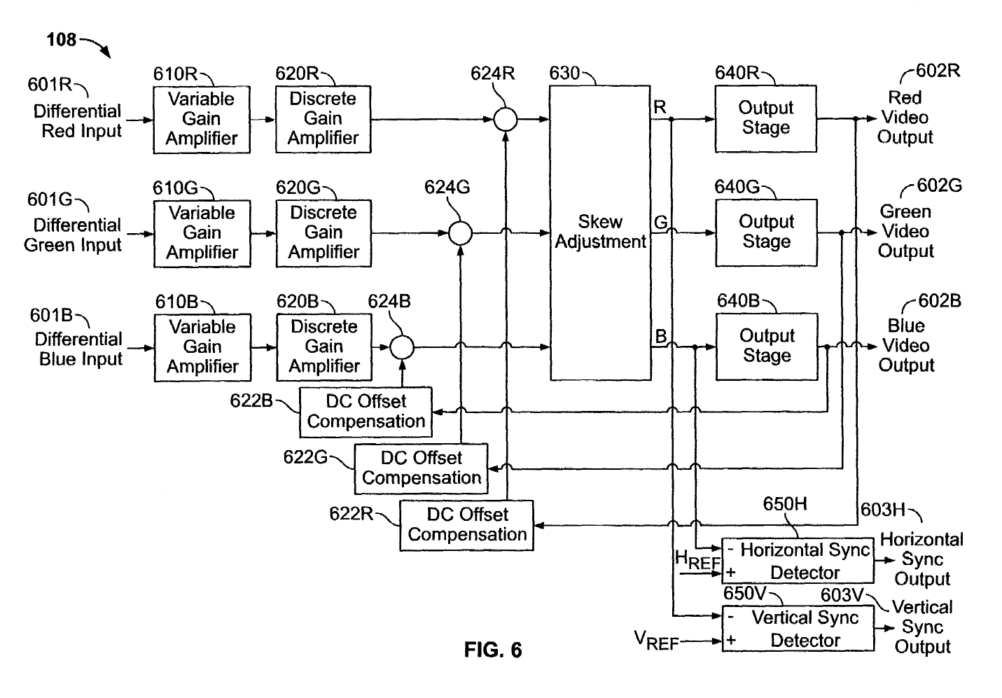

Receiver 108 receives the differential video signals from transmitter 104 via twisted pair cable 106. Receiver 108 processes the differential video signals to compensate for skew and signal degradation and then outputs the compensated video signals to a destination device such as projector 110. FIG. 6 is a block diagram of receiver 108 in accordance with an embodiment of the present invention.

In the embodiment of FIG. 6, Receiver 108 comprises variable gain amplifiers 610R, 610G and 610B, discrete gain amplifiers 620R, 620G and 620B, skew adjustment circuit 630; output stages 640R, 640G and 640B, DC offset compensation circuits 622R, 622B and 622G, and sync detectors 650H and 650V. Receiver 108 may also include differential output terminals (not shown) that output a buffered and/or amplified version of the input signals for daisy chaining to other receivers.

The differential video input signals 601 (e.g. 601R, 601G and 601B) are coupled to the respective variable gain amplifiers 610 and discrete gain amplifiers 620. Each variable gain amplifier 610 works together with the corresponding discrete gain amplifier 620 to compensate a respective one of the differential input video signals for insertion losses resulting from communication of the signal from transmitter 104 to receiver 108 over twisted pair cable 106. In one or more embodiments, each variable gain amplifier 610 is capable of providing a controllable, variable amount of gain over a range from zero (0) to a maximum value (K), and each discrete gain amplifier 620 provides amplification in controllable, discrete multiples of K (e.g. 0K, 1K, 2K, etc). Together, variable gain amplifiers 610 and discrete gain amplifiers 620 provide controllable amounts of variable gain over an amplification range equal to the sum of the maximum gain of variable gain amplifiers 610 and the maximum gain of discrete gain amplifiers 620. In one or more embodiments, K represents the amount of gain typically required to compensate for signal losses over a known length of cable (e.g. 300 feet).

In one or more embodiments, the total amount of gain provided by variable gain amplifiers 610 and discrete gain amplifiers 620 may be selected based on the length of cable 106, or may be automatically controlled, as described in more detail in co-pending U.S. patent application Ser. No. 11/309,122, entitled “Method And Apparatus For Automatic Compensation Of Video Signal Losses From Transmission Over Conductors”, specification of which is herein incorporated by reference.

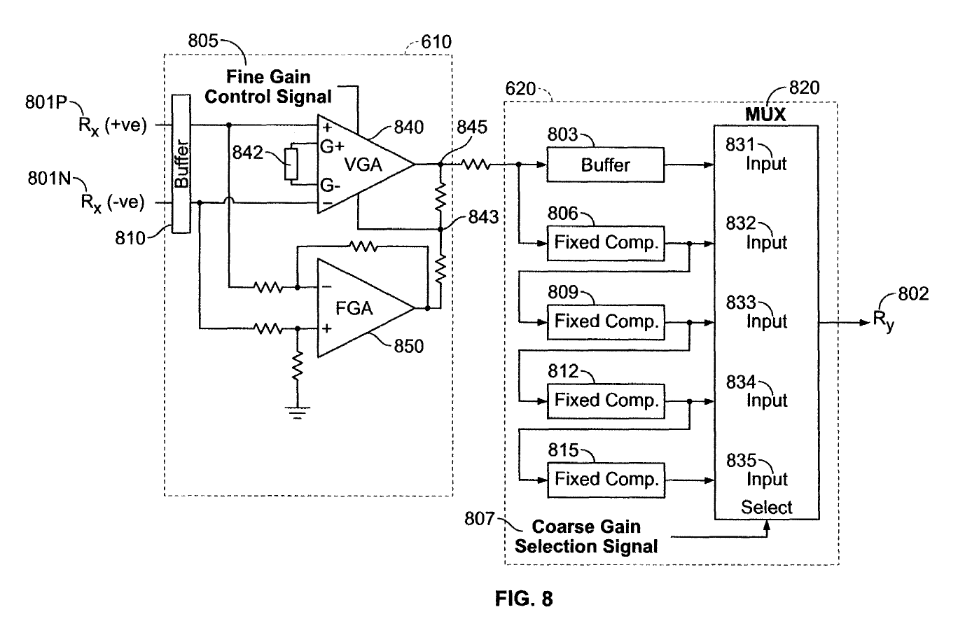

FIG. 8 is an illustration of a variable gain amplifier 610 and a discrete gain amplifier 620 in one embodiment of the invention. FIG. 8 shows a variable gain amplifier 610 and discrete gain amplifier 620 for a single video signal component, namely the red color component of an RGB signal (designated R_{X} in FIG. 8). However, it will be understood that in one or more embodiments each color component is provided with its own variable gain amplifier 610 and discrete gain amplifier 620, as shown, for example, in FIG. 6.

In the embodiment of FIG. 8, variable gain amplifier 610 provides amplification over an initial amplification range of zero up to a maximum gain (represented herein by the letter “K”). Discrete gain amplifier 620 provides selectable, discrete amounts of frequency dependent gain in multiples of K. For example, in the embodiment of FIG. 8, discrete gain amplifier 620 provides selectable gain in the amounts of 0K, 1K, 2K, 3K or 4K. Together, variable gain amplifier 610 and discrete gain amplifier 620 provide continuously variable gain with values from 0 to 5K over a desired frequency range. The frequency range may be determined based on noise considerations.

In the embodiment of FIG. 8, variable gain amplifier 610 includes a fixed gain amplifier circuit (FGA) 850, a variable gain amplifier circuit (VGA) 840, and a compensation circuit 842. VGA 840 and FGA 850 are both coupled to the differential input signals R_{X}(+ve) 801P and R_{X}(−ve) 801N. The coupling may be via a differential line buffer, e.g. 810, to prevent unbalancing of the transmission line. FGA 850 converts the differential video input signal to a single ended output with fixed gain. VGA 840 adds a controllable amount of variable (DC and AC Compensation) gain to the differential video input signal. The outputs of FGA 850 and VGA 840 are summed at node 843. The resulting summed signal is provided to the input of discrete gain amplifier 620 from node 845.

The amount of gain supplied by VGA 840 is controlled by Fine Gain Control Signal 805 supplied, for example, by a microcontroller. Compensator circuit 842 is used to set the desired frequency response of VGA 840. The fine gain control of VGA 840 compensates for both DC and AC signal losses in cable lengths of 0 feet to N feet (e.g. 300 feet).

If the maximum gain “K” provided by variable gain amplifier 610 corresponds to the insertion loss exhibited by 300 feet of CAT5 cable, then variable gain amplifier 610 can provide variable signal compensation for zero (0) to 300 feet of CAT5 cable. In the illustration of FIG. 8, the amount of gain between 0 and K (e.g. for between 0 and 300 foot lengths of CAT5 cable) provided by variable gain amplifier 610 is controlled by fine gain control signal 805. For longer lengths of cable, additional signal amplification is required. In the embodiment of FIG. 8, that additional signal amplification is provided by discrete gain amplifier 620.

Discrete gain amplifier 620 provides additional compensation for longer line lengths in discrete amounts of “K”. For example, for a cable length of 450 feet, 1.5K of total compensation is required. In this case, discrete gain amplifier 620 provides 1K (300 feet) of compensation, while variable gain amplifier 610 provides the remaining 0.5K (150 feet) of compensation.

In the embodiment of FIG. 8, discrete gain amplifier 620 comprises a multiplexer 820, a zero-gain buffer 803, and a plurality of fixed gain compensation circuits 806, 809, 812 and 815. Each fixed compensation circuit provides an amount of gain that is approximately equal to the maximum amount of gain provided by variable gain amplifier 610 (e.g. “K”). However, each fixed compensation circuit may include noise compensation circuits to compensate for noise in the longer cable lengths.

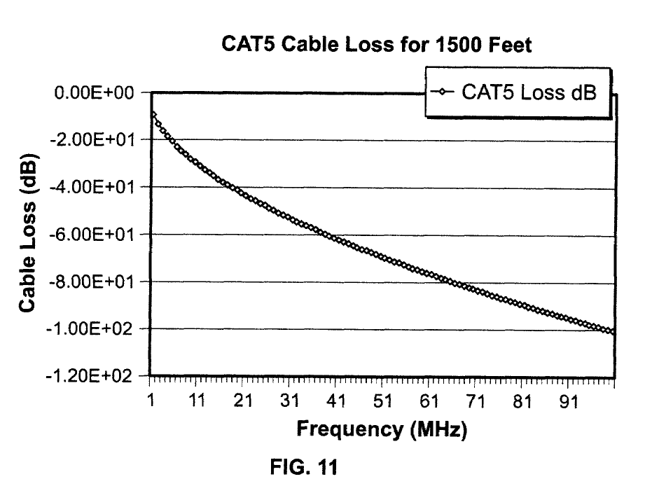

The amount of gain required to compensate for insertion losses resulting from transmission of video signals over long cable lengths will tend to increase the noise in the video signal. For instance, as illustrated in FIG. 11, the gain required to compensate for insertion loss for a 40 MHz video signal transmitted over 1500 feet of CAT5 cable is approximately 62 dB, or a voltage gain of approximately 1,259. At such large amplification, the effect of amplified input noise becomes significant. Noise is not desirable and will show up as sparkles in the video display. To reduce the noise problem, noise filters may be incorporated in one or more discrete gain amplifier stages. Therefore, each fixed compensation circuit (e.g. 806, 809, 812, and 815) may include an appropriate noise filter (e.g. low-pass filter to attenuate noise beyond a certain frequency) as well as the fixed gain “K”. Noise compensation is further described in co-pending U.S. patent application Ser. No. 11/309,123, entitled “Method And Apparatus For Automatic Reduction Of Noise In Video Transmitted Over Conductors”, specification of which is herein incorporated by reference.

In the embodiment of FIG. 8, input 831 of multiplexer 820 is connected to the output of buffer 803 (i.e. the buffered output signal from variable gain amplifier 610). Input 832 is connected to the output of compensation circuit 806 (i.e. the output signal from variable gain amplifier 610 after it has been amplified by compensation circuit 806). Input 833 is connected to the output of compensation circuit 809 (i.e. the output signal from variable gain amplifier 610 after having been amplified by compensation circuits 806 and 809). Input 834 is connected to the output of compensation circuit 812 (i.e. the output signal from variable gain amplifier 610 after having been amplified by compensation circuits 806, 809 and 812). Input 835 is connected to the output of compensation circuit 815 (i.e. the output signal from variable gain amplifier 610 after having been amplified by compensation circuits 806, 809, 812 and 815). If K is the amount of gain provided by each compensation circuit, then the additional gain applied to the output signal from variable gain amplifier 610 is 0K, 1K, 2K, 3K or 4K, depending on which of inputs 831, 832, 833, 834 or 835 is selected. If the amount of gain supplied by variable gain amplifier 610 is “J” (i.e. a value between 0 and K), the total amount of gain provided by variable gain amplifier 610 and discrete gain amplifier 620 is J, J+K, J+2K, J+3K or J+4K, depending on which of inputs 831, 832, 833, 834 or 835 is selected.

In the embodiment of FIG. 8, the fixed amount of compensation provided by each of compensation of circuits 806, 809, 812 and 815 is approximately equal to the maximum compensation provided by variable gain amplifier 610. However, it will be obvious to those of skill in the art that the amount of compensation provided by each of the compensation circuits 806, 809, 812 and 815 may be greater or less than the maximum provided by variable gain amplifier 610. Further, the discrete amount of compensation provided by each of compensation circuits 806, 809, 812 and 815 need not be the same.

The connection of either of inputs 831, 832, 833, 834 or 835 to output 802 of multiplexer 820 is controlled by coarse gain selection signal 807. In one or more embodiments, coarse gain selection signal 807 is generated by a micro-controller, which determines both the coarse gain selection signal 807 and the fine gain control signal 805 based on the actual loss in the reference signal as detected in the video signal received from the transmitter.

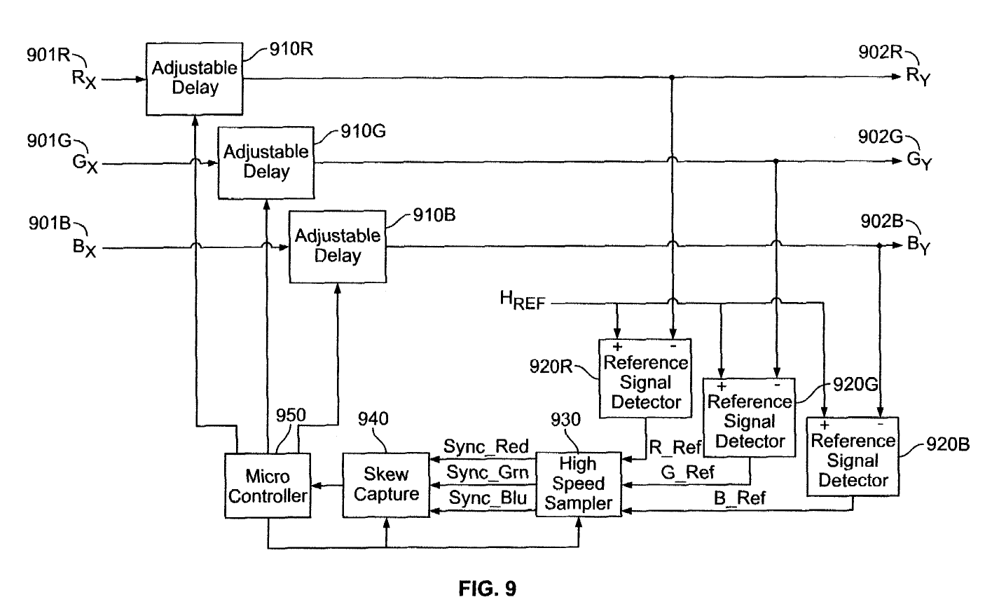

Skew compensation is performed through Skew Adjustment circuit 630. An embodiment of skew adjustment circuit 630 is illustrated in FIG. 9. As illustrated, skew adjustment is accomplished by first recovering the reference signal (H_{REF}) from each video component at the output of adjustable delay circuit 910. Skew compensation is accomplished by measuring the skew (i.e. difference in arrival time) between the reference signals in the color component signals using the circuit comprising: reference signal detectors 920, high speed sampler 930, skew capture circuit 940, and micro-controller 950; and then applying compensating delays to the fastest arriving signals with adjustable delay circuits 910. In FIG. 9, subscripts “X” and “Y” for each of the R, G, and B video signals are used to refer to the input signal to the skew adjustment circuit and the output signals from the skew adjustment circuit, respectively.

In one or more embodiments, each reference signal detector 920 comprises a comparator which compares the respective video signal to a negative reference voltage threshold, H_{REF}, generating a pulse when the reference signal is detected in the video signal. For example, signal detector 920R generates an output reference pulse signal R_ref corresponding to detection of the reference signal in the red component signal R_{Y}. Similarly, signal detector 920G generates an output reference pulse signal G_ref corresponding to detection of the reference signal in the green component signal G_{Y}, and signal detector 920B generates an output reference pulse signal B_ref corresponding to detection of the reference signal in the blue component signal B_{Y}.

The three reference pulse signals generated by reference signal detectors 920 feed into high speed sampler 930 which takes digital measurements of the recovered reference pulse signals. The digital outputs of high speed sampler 930 (i.e. Sync_Red, Sync_Grn, and Sync_Blu) feed to skew capture circuit 940, wherein the skew is determined and subsequently fed to micro-controller 950. Micro-controller 950 determines the appropriate delay to be applied to each component signal to compensate for the measured skew, and commands adjustable delay circuits 910 to apply the appropriate delay to the two earliest arriving color component signals such that they will line up in time with the slowest arriving component signal.

A skew adjustment circuit is described in more detail in co-pending U.S. patent application Ser. No. 11/309,120, entitled “Method And Apparatus For Automatic Compensation Of Skew In Video Transmitted Over Multiple Conductors”, the specification of which is incorporated by reference herein.

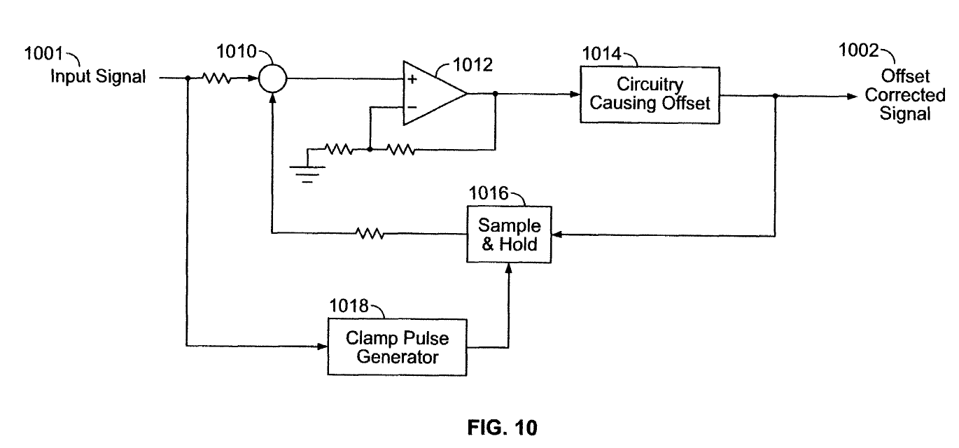

DC Offset Compensation circuit 622 of FIG. 6 and Offset Correction circuit 440 of FIG. 4 (referred to collectively as “DC Offset Compensation”) may be configured as illustrated in FIG. 10.

As illustrated, the DC restore circuit comprises: summing node 1010; amplifier 1012; Circuitry Causing Offset 1014; Sample & Hold circuit 1016; and Clamp Pulse Generator circuit 1018. The DC restore circuit operates on Input Signal 1001 to generate the clamped video signal, i.e., Offset Corrected Signal 1002. The offset signal (i.e. output of Sample & Hold circuit 1016) is generated when the clamp pulse is received from Clamp Pulse generator 1018.

Generally, clamping of the video signal with respect to ground involves detecting the offset voltage level. This may be accomplished in one or more embodiments of the present invention by sampling the back porch to obtain a reference for the video signal. This is because the voltage at the back porch of all video signals should be zero. Thus, measuring the voltage level at the back porch produces an offset voltage which may be applied to the video signal through a feedback path, continuously, until the back porch is restored (or clamped) to a ground level.

Input Signal 1001, e.g. video signal which includes the horizontal sync signal, is used by Clamp Pulse Generator 1018 to determine the back porch period (i.e. falling edge of the horizontal sync signal). The output of clamp pulse generator 1018 (i.e. clamp pulse) controls when Sample & Hold circuit 1016 samples the output video signal 1002 to generate an offset voltage equivalent in magnitude to the back porch voltage level, but with opposite polarity. Thus, the offset voltage feeds back at node 1010 to remove the DC offset error in the video signal.

DC offset correction circuits and methods are described in co-pending U.S. patent application Ser. No. 11/309,558, entitled “Method And Apparatus For DC Restoration Using Feedback”, specification of which is herein incorporated by reference.

Referring back to FIG. 6, Sync Output signals 603, which is output of Sync Detector 650, comprises primarily of Horizontal Sync and the Vertical Sync signals. In one embodiment of the present invention, the Horizontal Sync and the Vertical Sync signals are generated by comparing the Red (i.e. R_{Y}) and the Blue (i.e. B_{Y}) outputs of Skew Adjustment circuit 630 against a negative voltage level. A comparator may be used for such comparison. Thus, the Vertical Sync signal is generated when the R_{Y} output of Skew Adjustment circuit 630 meets the negative voltage threshold level, V_{REF}; and the Horizontal Sync signal is generated when the B_{Y} output of Skew Adjustment circuit 630 meets the negative voltage threshold level, H_{REF}.

Video Output 602 may be generated by stripping the sync signals from the video signal components at Output Stage 640. The sync stripping circuit may simply comprise a switch which grounds the video output during the sync period. For example, the circuit may be such that when either the Vertical Sync or the Horizontal Sync pulse is high, the video output (i.e. 602) is switched to ground; otherwise, the video output is switched to the corresponding video signal output of Skew Adjustment circuit 630. This is illustrated in FIG. 7.

As illustrated, R_{X} 701 is the video source from the output of Skew Adjustment circuit 630, and R_{Y} 702 is the stripped video output. The Vertical Sync signal (i.e. V_{Sync}) is wired-ORed with the Horizontal Sync signal (i.e. H_{Sync}) to generate the Select signal. When the Select signal is true (“T”) the video output, R_{Y} 702, is coupled to ground through switch 710 to remove the sync pulse. Otherwise, i.e. when the Select signal is false (“F”), the video output R_{Y} 702 is coupled to the input signal, R_{X} 701.

Thus, a method and apparatus for automatic compensation of video transmitted over long distances using twisted pair cables have been presented. It will be understood that the above described arrangements of apparatus and the method therefrom are merely illustrative of applications of the principles of this invention and many other embodiments and modifications may be made without departing from the spirit and scope of the invention as defined in the claims.

What is claimed is:

1. An apparatus for transmission of video over twisted pair conductors comprising:
a cable having a plurality of twisted pair conductors;
a transmitter having a first connector configured for receiving a first video signal from a source and a second connector configured to be couplable to a first end of said cable, said transmitter configured to drive a second video signal comprising said first video signal and a reference signal having a known characteristic onto said cable; and
a receiver having a third connector configured to be couplable to a second end of said cable for receiving said second video signal from said transmitter, said receiver having a second compensation circuit configured to automatically recreate said known characteristic of said reference signal in said second video signal thereby recovering said first video signal.

2. The apparatus of claim 1, wherein said first video signal comprises at least one component of a formatted video signal.

3. The apparatus of claim 2, wherein said at least one component of said first video signal comprises:
a Red component of an RGB formatted video signal;
a Green component of said RGB formatted video signal; and
a Blue component of said RGB formatted video signal.

4. The apparatus of claim 3, wherein said video signal further comprises at least one Synchronization signal.

5. The apparatus of claim 1, wherein said first video signal comprises at least one component of a formatted video signal and at least one Synchronization signal.

6. The apparatus of claim 5, wherein said first compensation circuit comprises:
an input amplifier circuit for each of said at least one component of a formatted video signal, said input amplifier circuit employing an offset correction feedback circuit for removal of DC offset in said first video signal component;
a polarity converter circuit configured to assure polarity of said at least one Synchronization signal; and
a differential amplifier driver circuit configured to generate said second video signal, wherein a positive terminal of said differential amplifier driver circuit is to said input amplifier circuit and a negative terminal of said differential amplifier driver circuit is coupled to the output of said polarity converter circuit coupled to is the synchronization signals.

7. The apparatus of claim 1, wherein said second video signal comprises a pair of differential drive signals for each pair of said plurality of twisted pair conductors.

8. The apparatus of claim 1, wherein said second compensation circuit comprises:
a variable gain amplifier circuit for DC and AC adjustment;
a skew adjustment circuit for skew compensation; and
a controller circuit controlling said variable gain amplifier circuit and said skew adjustment circuit for automatic correction of said second video signal to regenerate said first video signal.

9. An apparatus for transmission of video over twisted pair conductors comprising:
a cable having a plurality of twisted pair conductors;
a transmitter having a first connector configured for receiving a plurality of video component signals and at least one synchronization signal from a source, said transmitter having a second connector configured to be coupled to a first end of said cable, said transmitter having a first compensation circuit configured for generating a pair of differential video signals from each of said plurality of video component signals and said at least one synchronization signal, wherein each pair of said differential video signals drives one pair of said plurality of twisted pair conductors; and
a receiver having a third connector configured to be coupled to a second end of said cable for receiving said differential video signals from said transmitter, said receiver having a second compensation circuit which automatically adjusts to achieve full recovery of said first video signal upon detection of said differential video signals on said cable.

10. The apparatus of claim 9, wherein said plurality of video signal components comprises:
a Red component of an RGB formatted video signal;
a Green component of said RGB formatted video signal; and
a Blue component of said RGB formatted video signal.

11. The apparatus of claim 9, wherein said first compensation circuit comprises:
an input amplifier circuit for each of said plurality of video component signals, said input amplifier circuit employing an offset correction feedback circuit for removal of DC offset;
a polarity converter circuit configured to assure polarity of said at least one Synchronization signal; and
a differential amplifier driver circuit coupled to a sum of outputs of said input amplifier circuit and said polarity converter circuit, wherein said differential amplifier driver circuit is configured to generate said differential video signals.

12. The apparatus of claim 9, wherein said second compensation circuit comprises:
a variable gain amplifier circuit for DC and AC adjustment;
a skew adjustment circuit for skew compensation; and
a controller circuit controlling said variable gain amplifier circuit and said skew adjustment circuit for automatic correction of said differential video signals to regenerate said first video signal.

13. A method for transmission of video over twisted pair conductors comprising:
receiving a plurality of video component signals and at least one synchronization signal from a source;
generating a pair of differential video signals from each of said plurality of video component signals and said at least one synchronization signal, wherein each pair of said differential video signals drives one pair of a plurality of twisted pair conductors;
detecting presence of said pair of differential video signals on said plurality of twisted pair conductors; and
receiving and applying compensation to automatically adjust said differential video signals to achieve full recovery of said first video signal upon detection of said differential video signals on said cable.

14. The method of claim 13, wherein said detecting said presence of said pair of differential video signals comprises:
adjusting loop gains of a receiver circuit starting from maximum until a fixed sync pulse level is detected.

15. The method of claim 13, wherein said plurality of video signal components comprises:
a Red component of an RGB formatted video signal;
a Green component of said RGB formatted video signal; and
a Blue component of said RGB formatted video signal.

16. An apparatus for receiving video transmitted over twisted pair conductors comprising:
a connector configured to be couplable to a twisted pair cable bundle for receiving video signals having a plurality of components, wherein each of said plurality of components of said video signal includes a reference signal with known characteristics at a source of said video signals;
a first compensation circuit coupled to said connector and configured to automatically detect said reference signal in said connector and recover said known characteristics of said reference signal in each of said plurality of components of said video signals;
a skew compensation circuit coupled to said first compensation circuit and configured to automatically time-align said reference signals in said plurality of components, wherein said skew compensation circuit is further coupled to a video output connector; and
a feedback compensation circuit coupled to said skew compensation circuit and configured to automatically clamp said video signals with respect to ground.

17. The apparatus of claim 16, wherein said plurality of components of said video signal comprises:
a Red component of an RGB video;
a Green component of said RGB video; and
a Blue component of said RGB video.

18. The apparatus of claim 17, wherein said video signal further comprises at least one Synchronization signal.

19. The apparatus of claim 16, wherein said first compensation circuit comprises:
a variable gain amplifier circuit for each of said plurality of components; and
a processing unit coupled to said variable amplifier circuit, wherein said processing unit is configured to determine loss in said reference signal due to transmission over said twisted pair cable and commands said variable gain amplifier circuit to a gain to compensate for said loss.

20. The apparatus of claim 19, wherein said gain to compensate for said loss comprises low frequency and high frequency amplification.
